(19) United States
(12) Patent Application Publication
(10) Pub. No.: US 2025/0309230 A1
(43) Pub. Date: Oct. 2, 2025

(54) AGING METHOD OF LITHIUM METAL SECONDARY BATTERY

(71) Applicant: HONDA MOTOR CO., LTD., Tokyo (JP)

(72) Inventors: Masaki MATSUZAWA, Saitama (JP); Kazuki SAIMEN, Saitama (JP); Takeshi FUJINO, Saitama (JP)

(21) Appl. No.: 19/064,741

(22) Filed: Feb. 27, 2025

(30) Foreign Application Priority Data
Mar. 30, 2024 (JP) 2024-058354

(51) Int. Cl. H01M 4/04

(52) U.S. Cl. CPC H01M 4/0447

(57) ABSTRACT

An aging method of a lithium metal secondary battery according to an embodiment of the present invention is the aging method of the lithium metal secondary battery including an electrode laminated body having a positive electrode layer, a separator, and a negative electrode layer laminated in this order, and an electrolytic solution, the negative electrode layer including a lithium-containing metal layer, and the aging method includes: a wetting process of holding the lithium metal secondary battery under specified conditions and a first charging process of starting charging of the lithium metal secondary battery under specified conditions.

This application is based on and claims the benefit of priority from Japanese Patent Application No. 2024-058354, filed on 30 Mar. 2024, the content of which is incorporated herein by reference.

### BACKGROUND OF THE INVENTION

### Field of the Invention

The present invention relates to an aging method of a lithium metal secondary battery.

### Related Art

In recent years, research and development have been conducted on secondary batteries that contribute to energy efficiency in order to enable more people to secure access to affordable, reliable, sustainable, and advanced energy. As such a secondary battery, a lithium secondary battery is known which is configured such that a compound containing lithium is used as a positive electrode active material of a positive electrode layer, lithium ions are moved from the positive electrode active material to a negative electrode layer during charging, and the lithium ions are moved from the negative electrode layer to the positive electrode active material during discharging. In the lithium secondary battery having such a configuration, since the lithium is in the positive electrode active material immediately after manufacture, it is common to perform aging including a charging process (Patent Document 1).

Patent Document 1: Japanese Unexamined Patent Application, Publication No. 2024-500687

### SUMMARY OF THE INVENTION

Now, in technology regarding secondary batteries, one problem is to increase capacity. As a high-capacity lithium secondary battery, a lithium metal secondary battery is known. For the lithium metal secondary battery, a lithium-containing metal layer is used as a negative electrode active material layer, lithium ions are deposited on the lithium-containing metal layer during charging to generate a lithium metal layer, and the lithium ions released from the lithium metal layer are occluded by a positive electrode during discharging. However, according to studies by the present inventors, when an electrolyte concentration of electrolytic solution of the lithium metal secondary battery is as high as 1.0 mol/L to 3.0 mol/L, since the lithium-containing metal layer does not absorb the electrolytic solution, the electrolytic solution is less likely to permeate into an electrode laminated body. In addition, since wettability of the electrolytic solution is low in the lithium-containing metal layer, lithium is less likely to be deposited during charging for aging, a lithium deposition portion varies, and a dense lithium metal layer is less likely to be formed. Therefore, the lithium metal secondary battery after aging likely to cause a charging failure, defective products due to a slight short circuit such as a sudden drop of a voltage in a charging state are likely to be generated, and a yield rate of aging is low.

The present invention is implemented in consideration of the above situations, and an object is to provide an aging method of a lithium metal secondary battery that can form a dense lithium metal layer, increase a yield rate, and shorten aging time. Accordingly, the present invention contributes to energy efficiency.

In order to solve the problem, the present inventors have found that it is effective to hold a lithium metal secondary battery at a predetermined temperature for predetermined time and then to start charging at a predetermined charging rate while pressurizing it with a predetermined pressurization pressure, and have completed the present invention. Therefore, the present invention provides the following.

(1) An aging method of a lithium metal secondary battery including an electrode laminated body having a positive electrode layer, a separator, and a negative electrode layer laminated in this order, and an electrolytic solution, the negative electrode layer including a lithium-containing metal layer, the aging method including: a wetting process of holding the lithium metal secondary battery under a temperature environment of 20° C. or higher and 40° C. or lower for a holding time of 24 hours or longer and 60 hours or shorter; and a first charging process of starting charging of the lithium metal secondary battery at a charging rate of 0.05 C or higher and 0.20 C or lower while imparting a pressurization pressure of 400 kPa or more and 650 kPa or less in a lamination direction of the electrode laminated body under the temperature environment of 20° C. or higher and 40° C. or lower, and ending charging at a time point at which a voltage falls within a range of 4.1 V or higher and 4.3 V or lower.

According to the aging method of the lithium metal secondary battery in (1), since the temperature and the holding time in the wetting process are within the above ranges, the electrolytic solution is likely to permeate through the entire electrode laminated body. Then, since the pressurization pressure and the charging rate at a start of charging in the first charging process are within the above ranges, a lithium metal layer to be formed on a surface of the lithium-containing metal layer becomes dense, a yield rate of aging is improved, and aging time can be shortened.

(2) In the aging method of the lithium metal secondary battery as described in (1), the method further includes: a discharging process of discharging the lithium metal secondary battery charged by the first charging process until the voltage becomes 2.65 V; and a second charging process of charging the lithium metal secondary battery discharged by the discharging process until the voltage becomes 3.72 V.

According to the aging method of the lithium metal secondary battery in (2), since the discharging process and the first charging process are conducted further, each layer of the electrode laminated body of the lithium metal secondary battery is stabilized, and the yield rate of aging is improved.

(3) In the aging method of the lithium metal secondary battery as described in (1) or (2), the pressurization pressure is increased continuously or stepwise in the first charging process.

According to the aging method of the lithium metal secondary battery in (3), since density in a thickness direction of lithium to be deposited can be adjusted by pressurizing the lithium metal secondary battery according to a charging state of the lithium metal secondary battery, the lithium metal layer to be generated in the first charging process is more likely to be dense.

(4) In the aging method of the lithium metal secondary battery as described in (3), the pressurization pressure at an end of charging is within a range of 650 kPa or more and 900 kPa or less in the first charging process.

According to the aging method of the lithium metal secondary battery in (4), since the pressurization pressure at the end of charging in the first charging process is within the above range, lithium deposition density and electrolytic solution permeability are well-balanced, and further it is unlikely that the lithium metal secondary battery is pressurized with an excessive pressure and the electrolytic solution is pushed out. Thus, the yield rate of aging is improved.

(5) In the aging method of the lithium metal secondary battery as described in any one of (1) to (4), the charging rate is increased continuously or stepwise in the first charging process.

According to the aging method of the lithium metal secondary battery in (5), since charging is conducted at a low charging rate at the start of charging so that a dense lithium metal layer is likely to be formed on the lithium-containing metal layer and then the charging rate is increased, a bonding surface of the lithium-containing metal layer and the deposited lithium is uniform in particular, and both formation of the dense lithium metal layer and shortening of the aging time can be achieved.

According to the present invention, it is possible to provide an aging method of a lithium metal secondary battery that can form a dense lithium metal layer, increase a yield rate, and shorten aging time.

### BRIEF DESCRIPTION OF THE DRAWINGS

FIG. 1 is a sectional view of an example illustrating a configuration of an electrode laminated body included in a lithium metal secondary battery to be a treatment target in an aging method according to an embodiment of the present invention; and

FIG. 2 is a flowchart of an aging method of a lithium metal secondary battery according to an embodiment of the present invention.

### DETAILED DESCRIPTION OF THE INVENTION

Hereinafter, an embodiment of the present invention will be described with reference to the drawings. Note that the embodiment described below exemplifies the present invention and the present invention is not limited thereto.

In the present embodiment, a target of aging treatment is a lithium metal secondary battery. The lithium metal secondary battery includes an electrode laminated body and an electrolytic solution. The electrode laminated body and the electrolytic solution are housed in an exterior body and sealed.

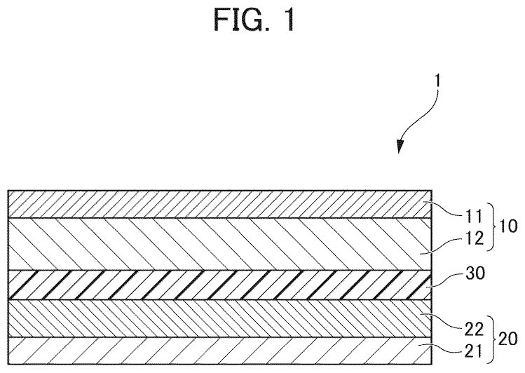

FIG. 1 is a sectional view of an example illustrating a configuration of the electrode laminated body included in the lithium metal secondary battery to be a treatment target in an aging method according to an embodiment of the present invention. As illustrated in FIG. 1, an electrode laminated body 1 is a laminated body including a positive electrode layer 10, a negative electrode layer 20, and a separator 30 laminated between the positive electrode layer 10 and the negative electrode layer 20.

The positive electrode layer 10 includes a positive electrode collector 11 and a positive electrode active material layer 12 laminated on a surface of the positive electrode collector 11. Examples of a material of the positive electrode collector 11 include aluminum, aluminum alloy, stainless steel, nickel, iron, and titanium.

The positive electrode active material layer 12 includes a positive electrode active material. The positive electrode active material is a lithium compound that releases lithium ions during discharging and occludes the lithium ions during charging. As the lithium compound, for example, a layered active material, a spinel type active material, or an olivine type active material can be used. Specific examples of the positive electrode active material include lithium cobalt oxide (LiCoO₂), lithium nickelate (LiNiO₂), Lithium nickel manganese cobalt oxide (NMC: LiNiₚMn_{q}CoᵣO₂ (p+q+r=1)), LiNiₚAl_{q}COᵣO₂ (p+q+r=1), lithium manganate (LiMn₂O₄), a different element-substituted Li-Mn spinel represented by Li₁₊ₓMn_{2-x-y}M_{y}O₄ (x+y=2, M=at least one kind selected from Al, Mg, Co, Fe, Ni, and Zn), lithium titanate (oxide containing Li and Ti), and lithium metal phosphate (LiMPO₄, M=at least one kind selected from Fe, Mn, Co, and Ni). The positive electrode active material layer 12 may further contain a conductive auxiliary agent and a binder.

The negative electrode layer 20 includes a negative electrode collector 21 and a lithium-containing metal layer 22 laminated on a surface of the negative electrode collector 21. Examples of a material of the negative electrode collector 21 include copper, copper alloy, nickel, and stainless steel.

For the lithium-containing metal layer 22, the lithium ions are deposited to generate a lithium metal layer during charging, and the lithium of the lithium metal layer is released during discharging. Therefore, a thickness of the negative electrode layer 20 is changed by charging and discharging. As a material of the lithium-containing metal layer 22, the lithium and metal that forms alloy with the lithium can be used. Examples of the metal that forms the alloy with the lithium include Mg, Si, Au, Ag, In, Ge, Sn, Pb, Al, and Zn.

As the separator 30, a porous body sheet or a nonwoven fabric sheet can be used for example. Examples of a material of the porous body sheet include polyolefin such as polyethylene and polypropylene, aramid, polyimide, and fluororesin. Examples of a material of the nonwoven fabric include glass fibers and cellulose fibers.

The electrolytic solution contains an organic solvent and an electrolyte. As the organic solvent, for example, cyclic carbonate, chain carbonate, cyclic ether, chain ether, hydrofluoroether (HFE), aromatic ether, sulfone, cyclic ester, chain carboxylic ester, and nitrile can be used. Examples of the cyclic carbonate include ethylene carbonate, propylene carbonate, vinylene carbonate, and fluoroethylene carbonate. Examples of the chain carbonate include dimethyl carbonate, diethyl carbonate, and ethyl methyl carbonate. Examples of the cyclic ether include tetrahydrofuran, 2-methyltetrahydrofuran, tetrahydropyran, 1,3-dioxolan, and 4-methyl 1,3-dioxolan. Examples of the chain ether include 1,2-dimethoxyethane, 1,2-diethoxyethane, ethoxymethoxyethane, and diethyl ether. Examples of the hydrofluoroether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, and 1,2-bis(1,1,2,2-tetrafluoroethoxy) ethane. An example of the aromatic ether is anisole. Examples of the sulfone include sulfolane and methylsulfolane. An example of the cyclic ester is γ-butyrolactone. Examples of the chain carboxylic ester include acetate, butyrate, and propionate. Examples of the nitrile include acetonitrile and propionitrile. For the organic solvent, one kind may be used alone, or two or more kinds may be used in combination.

The electrolyte is a supply source of the lithium ions that are charge transfer media, and contains lithium salt. Examples of the lithium salt include LiPF₆, LiBF₄, LiClO₄, LiASF₆, LiCF₃SO₃, LiC(CF₃SO₂)₃, LIN(CF₃SO₂)₂(LiTFSI), LIN(FSO₂)₂(LiFSI), and LiBC₄O₈. For the lithium salt, one kind may be used alone, or two or more kinds may be used in combination. A concentration of the electrolyte may be within a range of 1.0 to 4.0 mol/L for example, or may be within a range of 1.0 to 3.0 mol/L.

The exterior body can be expanded and contracted accompanying change in the thickness of the negative electrode layer 20 due to charging and discharging. As a material of the exterior body, a laminate film can be used. As the laminate film, a laminated film in a three-layer structure having an inner side resin layer, a metal layer and an outer side resin layer laminated in this order from an inner side can be used. The outer side resin layer may be a polyamide (nylon) layer or a polyethylene terephthalate (PET) layer for example, the metal layer may be an aluminum layer for example, and the inner side resin layer may be a polyethylene layer or a polypropylene layer for example.

Next, an aging method of the lithium metal secondary battery of the present embodiment will be described.

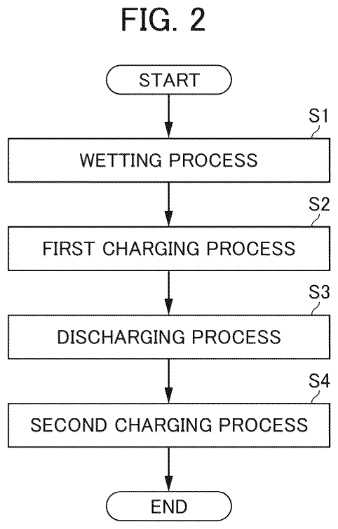

FIG. 2 is a flowchart of the aging method of the lithium metal secondary battery according to an embodiment of the present invention. As illustrated in FIG. 2, the aging method of the lithium metal secondary battery of the present embodiment includes a wetting process S1, a first charging process S2, a discharging process S3, and a second charging process S4.

In the wetting process S1, the lithium metal secondary battery is held under a temperature environment of 20° C. or higher and 40° C. or lower for a holding time of 24 hours or longer and 60 hours or shorter. The wetting process S1 can be conducted using a thermostatic bath for example. The wetting process S1 may be conducted in a state where the lithium metal secondary battery is not pressurized. By conditionally conducting the wetting process S1, the electrolytic solution uniformly permeates through the electrode laminated body 1 by the wetting process S1. Therefore, during charging in the next first charging process S2, a lithium metal layer is likely to be formed uniformly on a surface of the lithium-containing metal layer 22.

In the first charging process S2, charging of the lithium metal secondary battery after being held at a predetermined temperature for predetermined time in the wetting process is started at a charging rate of 0.05 C or higher and 0.20 C or lower while imparting a pressurization pressure of 400 kPa or more and 650 kPa or less in a lamination direction of the electrode laminated body 1 under the temperature environment of 20° C. or higher and 40° C. or lower. Charging is ended at a time point at which a voltage becomes 4.1 V.

Since the temperature and the pressurization pressure at a start of charging in the first charging process S2 are within the above ranges, interlayer resistance of the electrode laminated body 1 can be lowered while holding the electrolytic solution that has permeated through the electrode laminated body 1. In addition, since the charging rate at the start of charging is within the above range, the lithium metal layer to be formed on the surface of the lithium-containing metal layer 22 by charging becomes dense. While viscosity of the electrolytic solution decreases and the wettability increases as the temperature increases, since a film is excessively formed on a surface of a lithium negative electrode when the temperature becomes 45° C. or higher, 40° C. or lower is preferable. For a pressurization amount of initial charging, it is preferable to start from at least 0.2 C or lower and 300 kPa or more.

The pressurization pressure after the start of charging may be increased continuously or stepwise.
“Continuously” means to increase the pressurization pressure according to a state-of-charge (SOC) of the lithium metal secondary battery or the thickness of the lithium metal layer formed on the surface of the lithium-containing metal layer 22 of the negative electrode layer 20 for example.
“Stepwise” means to increase the pressurization pressure when the state-of-charge of the lithium metal secondary battery or the thickness of the lithium metal layer formed on the surface of the lithium-containing metal layer 22 of the negative electrode layer 20 becomes a preset value. An increase value of the pressurization pressure is not limited in particular, and may be set such that the pressurization pressure at an end of charging falls within a range of 650 kPa or more and 900 kPa or less for example. The pressurization pressure at the end of charging with respect to the pressurization pressure after the start of charging may be within a range of 1.1 or more and 2.0 or less for example.

The charging rate after the start of charging may be increased continuously or stepwise.
“Continuously” means to increase the charging rate according to the state-of-charge of the lithium metal secondary battery or the thickness of the lithium metal layer formed on the surface of the lithium-containing metal layer 22 of the negative electrode layer 20 for example.
“Stepwise” means to increase the charging rate when the state-of-charge of the lithium metal secondary battery or the thickness of the lithium metal layer formed on the surface of the lithium-containing metal layer 22 of the negative electrode layer 20 becomes a preset value for example. The charging rate may be increased at the time point at which the state-of-charge of the lithium metal secondary battery becomes 20% or higher. An increase value of the charging rate is not limited in particular, and may be set such that an average charging rate falls within a range of 0.10 C or higher and 0.30 C or lower for example. The average charging rate with respect to the charging rate at the start of charging may be within a range of 1.1 or more and 4.0 or less for example.

In the discharging process S3, the lithium metal secondary battery charged in the first charging process is discharged until the voltage becomes 2.65 V. Discharging may be conducted under the temperature environment of 20° C. or higher and 40° C. or lower for example
at a discharging rate of 1 C while imparting the pressurization pressure of 1000 kPa in the lamination direction of the electrode laminated body 1 of the lithium metal secondary battery.

In the second charging process S4, the lithium metal secondary battery discharged in the discharging process is charged until the voltage becomes 3.72 V. Charging may be conducted at the charging rate of 0.1 C while imparting the pressurization pressure of 1000 kPa in the lamination direction of the electrode laminated body 1 of the lithium metal secondary battery under the temperature environment of 20° C. or higher and 40° C. or lower for example.

According to the aging method of the lithium metal secondary battery of the present embodiment configured as above, since a holding temperature and the holding time in the wetting process S1 are within the above ranges, the electrolytic solution is likely to permeate through the entire electrode laminated body 1. Then, since the pressurization pressure and the charging rate at the start of charging in the first charging process S2 are within the above ranges, a lithium layer to be formed on the surface of the lithium-containing metal layer 22 becomes dense, a yield rate of aging is improved, and aging time can be shortened.

According to the aging method of the lithium metal secondary battery of the present embodiment, since the discharging process S3 and the second charging process S4 are conducted further, each layer of the electrode laminated body 1 of the lithium metal secondary battery is stabilized, and the yield rate of aging is improved. Note that the discharging process S3 and the second charging process S4 may be omitted in a case where the lithium metal secondary battery is to be immediately used after the first charging process S2.

In the case of increasing the pressurization pressure continuously or stepwise in the first discharging process of the aging method of the lithium metal secondary battery of the present embodiment, since density in a thickness direction of lithium to be deposited can be adjusted by pressurizing the lithium metal secondary battery according to a charging state of the lithium metal secondary battery, the lithium metal layer to be generated in the first charging process is more likely to be dense. In addition, in the case where the pressurization pressure at the end of charging is within the above range, lithium deposition density and electrolytic solution permeability are well-balanced, and it is unlikely that the lithium metal secondary battery is pressurized with an excessive pressure and the electrolytic solution is pushed out. Thus, the yield rate of aging is improved.

In the case of increasing the charging rate continuously or stepwise in the first charging process of the aging method of the lithium metal secondary battery of the present embodiment, since charging is conducted at a low charging rate at the start of charging so that a dense lithium metal layer is likely to be formed on the lithium-containing metal layer and then the charging rate is increased, a bonding surface of the lithium-containing metal layer and the deposited lithium is uniform in particular, and both formation of the dense lithium metal layer and shortening of the aging time can be achieved.

The aging method of the lithium metal secondary battery of the present embodiment has been described above, but the present invention is not limited to the embodiment described above. For example, a stand-still process of making the lithium metal secondary battery stand still may be provided between the first charging process S2 and the discharging process S3. In the stand-still process, the lithium metal secondary battery may be made to stand still in a state of no pressurization under the temperature environment of 20° C. or higher and 40° C. or lower for example. Stand-still time is within a range of one hour or longer and 50 hours or shorter for example.

### EXAMPLES

The present invention will be described with examples. Note that the present invention is not limited to the examples. In the present examples, the lithium metal secondary battery produced as below was used.

### Production of Positive Electrode

2 wt % acetylene black (AB) as an electron conductive material and 1.5 wt % polyvinylidene fluoride (PVDF) as a binding agent (binder) were premixed in N-methyl-2-pyrrolidone (NMP) as a dispersion solvent, and were wet-mixed in a rotating and revolving mixer to obtain premixed slurry. Subsequently, Li1Ni_{0.8}CO_{0.1}Mn_{0.1}O₂ (NCM811) as the positive electrode active material, a predoping material, and the obtained premixed slurry were mixed and dispersion treatment was conducted using a planetary mixer to obtain positive electrode paste. A median diameter of the NCM811 is 4 μm. Next, the obtained positive electrode paste was coated and dried on an aluminum positive electrode collector not including a primer layer, and was pressurized by roll pressing, and then a positive electrode in which a thickness of a positive electrode active material layer was 64 μm and density was 3.3 g/cm³ was obtained. Subsequently, drying was conducted in vacuum at 120° C. to form a positive electrode plate including the positive electrode active material layer. The obtained positive electrode plate was punched into a size of 30 mm×40 mm to obtain a positive electrode.

### Preparation of Negative Electrode

As a negative electrode, a clad material of copper foil having a thickness of 10 μm and lithium foil having a thickness of 20 μm was used. Punching was conducted so as to make electrode area be a size of 34 mm×44 mm to obtain a negative electrode.

### Preparation of Separator

As a separator, an alumina-coated polyethylene microporous film was used.

### Production of Electrolytic Solution

A mixed solvent was obtained by mixing dimethoxyethane (DME) and 1,1,2,2-tetrafluoroethyl-2,2,3,3-tetrafluoropropyl ether (TTE) at a mass ratio of 60:40. LiFSI was dissolved in the obtained mixed solvent at a concentration of 2.1 mol/L to produce electrolytic solution.

### Production of Lithium Metal Secondary Battery

Aluminum laminate for a secondary battery (made by Dai Nippon Printing Co., Ltd.) was heat-sealed and processed into a bag shape to produce an exterior container. A laminated body having a positive electrode, a separator, and a negative electrode laminated in this order was introduced into the exterior container, then the electrolytic solution was injected for 350 μL, and then an opening of the exterior container was heat-sealed to produce a lithium metal secondary battery.

### Example 1

The lithium metal secondary battery was put in a thermostatic bath adjusted to 25° C. and was held for 48 hours (the wetting process). Next, the lithium metal secondary battery was charged to 4.1 V at the charging rate of 0.10 C in the state of being pressurized with the pressure of 500 kPa in the lamination direction of the electrode laminated body. The pressurization pressure was increased continuously so that the pressure at the end of charging was 700 kPa (the first charging process). The first charging process was conducted in a thermostatic chamber at 25° C. Next, the lithium metal secondary battery charged in the first charging process was put in a thermostatic bath adjusted to 25° C., and was held for 24 hours without pressurization. Thereafter, the lithium metal secondary battery was discharged to 2.65 V at the discharging rate of 1 C in the state of being pressurized with the pressure of 1000 kPa in the lamination direction of the electrode laminated body (the discharging process). The discharging process was conducted in the thermostatic chamber at 25° C. Then, the discharged lithium metal secondary battery was charged to 3.7 V (80% by the state-of-charge (SOC) of the lithium metal secondary battery) at the charging rate of 0.1 C in the state of being pressurized with the pressure of 1000 kPa in the lamination direction of the electrode laminated body (the second charging process). The second charging process was conducted in the thermostatic chamber at 25° C. A above, aging of the lithium metal secondary battery was conducted.

### Examples 2 to 4, Comparative Examples 1 to 10

The temperature of the thermostatic bath in the wetting process was set to the temperature indicated in Table 1 below, and the holding time was set to the holding time indicated in Table 1 below. A pressurization condition in the first charging process was set to the pressurization condition indicated in Table 1 below, and a charging condition in the first charging process was set to the charging condition indicated in Table 1 below. Similarly to the example 1 except for the above, the aging of the lithium metal secondary battery was conducted. In the pressurization condition in Table 1, a start time pressure is the pressurization pressure at the start of charging, and an end time pressure is the pressurization pressure at the end of charging. A pressure difference is a value obtained by subtracting the pressurization pressure at the start of charging from the pressurization pressure at the end of charging. When the pressure difference is 0, it means that the pressurization pressure was fixed from the start of charging to the end of charging. In the charging condition in Table 1, a start time rate is the charging rate at the start of charging. “Yes” in charging rate switching means that the charging rate was switched to 1 C at the time point at which the state-of-charge (SOC) of the lithium metal secondary battery became 20%. “No” in the charging rate switching means that the charging rate was not switched. The average charging rate is an average of the charging rate from the start of charging to the end of charging. When the charging rate switching is “No”, the average charging rate and the start time rate are same.

### Evaluation

On the lithium metal secondary battery after the aging, the yield rate and a lithium deposition thickness of the negative electrode layer were evaluated as below. In addition, total time required from the wetting process to the second charging process was calculated as total aging time. The results are indicated in Table 1 below.

### Yield Rate

To the lithium metal secondary battery after the aging, discharging and charging were conducted twice under conditions below. The charged lithium metal secondary battery was discharged to the SOC 50% at the discharging rate of ⅓ C. An OCV of the lithium metal secondary battery at the SOC 50% was measured over time. The lithium metal secondary battery having the OCV of 3.9 V or lower after six hours from the start of measuring the OCV was determined to be slightly short-circuited and was defined to be defective, and the yield rate was calculated. The yield rate is preferably 90% or higher.

### Discharging and Charging Conditions

For discharging, the condition was to conduct constant-current discharging to 2.65 V at ⅓ C. For charging, the condition was to conduct constant-current charging at ⅓ C and then to conduct constant-voltage charging for 1.5 hours at 4.30 V.

### Thickness of Lithium Metal Layer of Negative Electrode Layer

The lithium metal secondary battery subjected to a charging and discharging cycle in the evaluation of the yield rate described above was charged so that the SOC becomes 100% by conducting CCCV charging of conducting the constant-current charging at ⅓ C and then conducting the constant-voltage charging for 1.5 hours at 4.30 V. The charged lithium metal secondary battery was disassembled to take out the negative electrode layer, and a total thickness of the lithium foil of the negative electrode layer and the lithium layer deposited on the surface was measured as the lithium metal layer using a micrometer. The total thickness of the lithium metal layer is preferably less than 49 μm.

TABLE 1

| | | | | | | | | | Evaluation | | |
|---|---|---|---|---|---|---|---|---|---|---|---|
| | | | First charging process | | | | | | | Thickness | |
| | Wetting process | | Pressurization condition | | | Charging condition | | | | of lithium | Total |
| | Temper- | Holding | Start time | End time | Pressure | Start time | Charging | Average | Yield | metal | aging |
| | ature | time | pressure | pressure | difference | charging | rate | charging | rate | layer | time |
| | (° C.) | (hours) | (kPa) | (kPa) | (kPa) | rate (C) | switching | rate (C) | (%) | (μm) | (hours) |
| Example 1 | 25 | 48 | 500 | 700 | 200 | 0.10 | No | 0.10 | 90 | 48 | 83 |
| Example 2 | 25 | 48 | 500 | 700 | 200 | 0.05 | Yes | 0.18 | 95 | 47 | 79 |
| Example 3 | 25 | 48 | 500 | 700 | 200 | 0.10 | Yes | 0.19 | 90 | 47 | 78 |
| Example 4 | 25 | 48 | 500 | 700 | 200 | 0.15 | Yes | 0.19 | 90 | 47 | 78 |
| Comparative | 25 | 48 | 150 | 300 | 150 | 0.10 | No | 0.10 | 90 | 51 | 83 |
| Example 1 | | | | | | | | | | | |
| Comparative | 25 | 48 | 150 | 300 | 150 | 0.05 | No | 0.05 | 95 | 49 | 93 |
| Example 2 | | | | | | | | | | | |
| Comparative | 25 | 48 | 700 | 700 | 0 | 0.05 | No | 0.05 | 75 | 44 | 93 |
| Example 3 | | | | | | | | | | | |
| Comparative | 25 | 48 | 700 | 700 | 0 | 0.10 | No | 0.10 | 75 | 47 | 83 |
| Example 4 | | | | | | | | | | | |
| Comparative | 25 | 48 | 700 | 700 | 0 | 0.20 | No | 0.20 | 75 | 44 | 78 |
| Example 5 | | | | | | | | | | | |
| Comparative | 25 | 48 | 700 | 700 | 0 | 0.30 | No | 0.30 | 75 | 44 | 76 |
| Example 6 | | | | | | | | | | | |
| Comparative | 25 | 48 | 1000 | 1000 | 0 | 0.10 | No | 0.10 | 50 | 50 | 83 |
| Example 7 | | | | | | | | | | | |
| Comparative | 25 | 48 | 1000 | 1000 | 0 | 0.05 | No | 0.05 | 80 | 44 | 93 |
| Example 8 | | | | | | | | | | | |
| Comparative | 25 | 24 | 1000 | 1000 | 0 | 0.05 | No | 0.05 | 50 | 44 | 69 |
| Example 9 | | | | | | | | | | | |
| Comparative | 45 | 5 | 1000 | 1000 | 0 | 0.05 | No | 0.05 | 75 | 50 | 50 |
| Example 10 | | | | | | | | | | | |

From the results in Table 1, it is recognized that, under the conditions of the examples 1 to 4 in which the temperature and the holding time in the wetting process and the pressurization pressure and the charging rate at the start of charging in the first charging process were within the ranges of the present invention, the lithium metal layer to be formed during charging is thin and dense, the yield rate is low, and the aging time can be shortened. In particular, it is recognized that the aging time can be shortened more under the conditions of the examples 2 to 4 in which the charging rate was switched in the first charging process.

In contrast, it is recognized that the lithium metal layer formed by charging becomes thick and denseness of the lithium metal layer decreases under the conditions of the comparative examples 1 and 2 in which the pressurization pressure at the start of charging in the first charging process was lower than the range of the present invention. It is recognized that the yield rate decreases under the conditions of the comparative examples 3 to 8 in which the pressurization pressure at the start of charging in the first charging process was higher than the range of the present invention.

Under the condition of the comparative example 9 in which the holding time in the wetting process was shorter than the range of the present invention and the pressurization condition and the charging condition in the first charging process were the same as those in the comparative example 8, the yield rate decreased as compared with the comparative example 8. This is because the electrolytic solution did not sufficiently permeate through the electrode laminated body in the wetting process.

Under the condition of the comparative example 10 in which the temperature in the wetting process was higher than the range of the present invention, the holding time was shorter than the range of the present invention, and the pressurization condition and the charging condition in the first charging process were the same as those in the comparative example 8, the yield rate decreased as compared with the comparative example 8, and the lithium metal layer formed by charging became thick. This is because byproducts were excessively generated by reaction of the negative electrode and the electrolytic solution in the wetting process and the wettability on a lithium surface decreased.

### EXPLANATION OF REFERENCE NUMERALS

1 electrode laminated body
10 positive electrode layer
11 positive electrode collector
12 positive electrode active material layer
20 negative electrode layer
21 negative electrode collector
22 lithium-containing metal layer
30 separator

What is claimed is:

1. An aging method of a lithium metal secondary battery including an electrode laminated body having a positive electrode layer, a separator, and a negative electrode layer laminated in this order, and an electrolytic solution, the negative electrode layer including a lithium-containing metal layer, the aging method comprising:
a wetting process of holding the lithium metal secondary battery under a temperature environment of 20° C. or higher and 40° C. or lower for a holding time of 24 hours or longer and 60 hours or shorter; and
a first charging process of starting charging of the lithium metal secondary battery at a charging rate of 0.05 C or higher and 0.20 C or lower while imparting a pressurization pressure of 400 kPa or more and 650 kPa or less in a lamination direction of the electrode laminated body under the temperature environment of 20° C. or higher and 40° C. or lower, and ending charging at a time point at which a voltage falls within a range of 4.1 V or higher and 4.3 V or lower.

2. The aging method of the lithium metal secondary battery according to claim 1, the method further comprising:
a discharging process of discharging the lithium metal secondary battery charged by the first charging process until the voltage becomes 2.65 V; and
a second charging process of charging the lithium metal secondary battery discharged by the discharging process until the voltage becomes 3.72 V.

3. The aging method of the lithium metal secondary battery according to claim 1, wherein the pressurization pressure is increased continuously or stepwise in the first charging process.

4. The aging method of the lithium metal secondary battery according to claim 3, wherein the pressurization pressure at an end of charging is within a range of 650 kPa or more and 900 kPa or less in the first charging process.

5. The aging method of the lithium metal secondary battery according to claim 1, wherein the charging rate is increased continuously or stepwise in the first charging process.
